(19) United States
(12) Patent Application Publication
(10) Pub. No.: US 2016/0372284 A1
(43) Pub. Date: Dec. 22, 2016

(54) Circumstances Control Device

(71) Applicant: O Plus Design International Corporation, Taipei City (TW)

(72) Inventor: Chun-Hui Lin, Taipei City (TW)

(21) Appl. No.: 14/740,448

(22) Filed: Jun. 16, 2015

(51) Int. Cl. H01H 47/00

(52) U.S. Cl. CPC H01H 47/00

(57) ABSTRACT

A circumstances control device is disclosed, comprising a plurality of switch units; an input unit, connected to each of the plurality of switch units; a mode selection mechanism, connected to the input unit; and a plurality of appliance devices, connected to the mode selection mechanism. As such, the mode selection mechanism may activate the appliance devices by using various modes with cooperation with the switch unit and the input unit, whereby some desired circumstances may be controlled according to different conditions without requiring complicated switch devices, achieving the efficacy of easy operation and use.

### FIELD OF THE INVENTION

The present invention relates to a circumstances control device, and particularly to a circumstances control device, where a mode selection mechanism may activate appliance devices by using various modes with cooperation with a switch unit and an input unit, whereby some desired circumstances may be controlled according to different conditions without requiring complicated switch devices, achieving the efficacy of easy operation and use.pe proofing, and a better heat isolation.

### DESCRIPTION OF THE RELATED ART

For an access to an appliance device, a user has to approach a position near the device to operate the appliance. For example, when the user desires to operate a projector, he/she has typically to activate the projector, pull down a projector screen, close up a curtain, adjust a room light, and the like, by a human labor.

However, this manual operation may cause the user to act with confusion due to complicated operational steps and a relatively larger operational space when a single user is involved. On the other hand, in the case that more than one user are involved in this operation, more labors are required to operate the various steps and thus an inconvenient operation issue may be caused in actual use.

Therefore, the applicant of this application developed a circumstances control device after research with efforts to improve the demerits encountered in the prior art.

### SUMMARY OF THE INVENTION

The present invention has an object to provide a circumstances control device, where a mode selection mechanism may activate appliance devices by using various modes with cooperation with a switch unit and an input unit, whereby some desired circumstances may be controlled according to different conditions without requiring complicated switch devices, achieving the efficacy of easy operation and use.

To achieve the above object, the circumstances control device according to the present invention comprises a plurality of switch units; an input unit, connected to each of the plurality of switch units; a mode selection mechanism, connected to the input unit; and a plurality of appliance devices, connected to the mode selection mechanism.

In an embodiment, each of the switch units is a trigger switch.

In an embodiment, each of the plurality of switch units is a button switch.

In an embodiment, some of the plurality of switch units is a trigger switch while the others are a button switch, respectively.

In an embodiment, the input unit is a digital port, and a power source input port is arranged between the input unit and each of the switch units.

In an embodiment, each of the plurality of power source input port is supplied with a voltage of 5V to 24V.

In an embodiment, the mode selection mechanism comprises a first mode unit, a second mode unit, a third mode unit, a fourth mode unit, a fifth mode unit, a sixth mode unit, and a seventh mode unit.

In an embodiment, each of appliance devices comprises a video/audio player device, a lightening device, an air-conditioner device, and a power-driven curtain.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention;

FIG. 2 is a schematic diagram of a connection state between a switch unit and an input unit according to the present invention; and

FIG. 3 is a schematic diagram of a use state according to the present invention.

### DESCRIPTION OF THE PREFERRED EMBODIMENTS

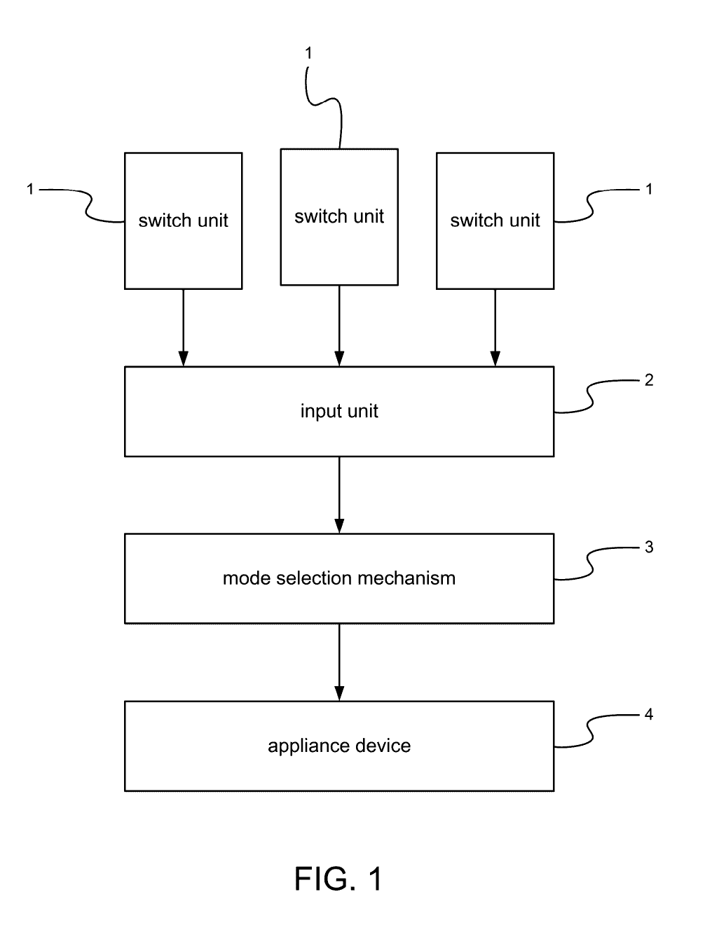

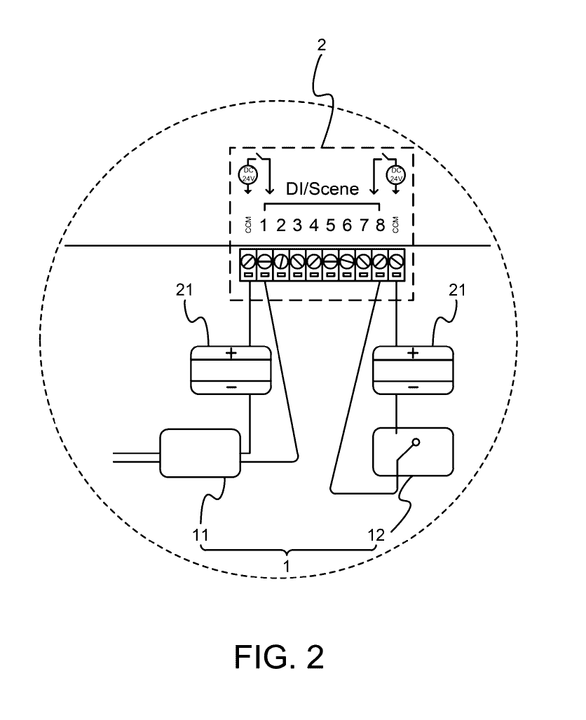

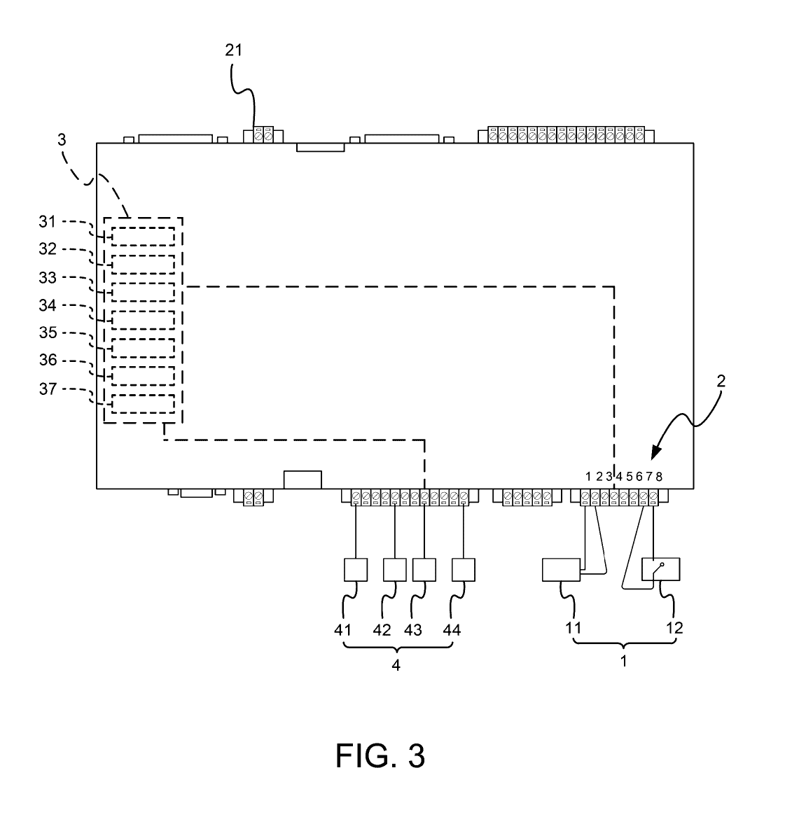

Referring to FIG. 1, FIG. 2, and FIG. 3, a schematic diagram of a basic architecture according to the present invention, a schematic diagram of a connection state between a switch unit and an input unit according to the present invention, and a schematic diagram of a use state according to the present invention are shown therein, respectively. As shown, the present invention is a circumstances control device, and which concludes a plurality of switch units 1, an input unit 2, a mode selection mechanism 3, and a plurality of appliance device 4.

The switch units 1 are each a trigger switch 11 or a button switch 12, and may be further a combination of the trigger switch 11 and the button switch 12.

The input unit 2 is connected to each of the plurality of switch units 1. The input unit 2 is a digital Input port. Further, a power source input port 21 is disposed between the input unit 2 and the trigger switch 11 and the button switch 12 of each of the switch units 1. Each of the power source input port 21 supplies a voltage of 5V to 24V.

The mode selection mechanism 3 is connected to the input unit 2, and at least includes a first mode unit 31, a second mode unit 32, a third mode unit 33, a fourth unit 34, a fifth mode unit 35, a six mode unit 36, and a seven mode unit 37.

Each of the appliance devices 5 is connected to the mode selection mechanism 3, and at least includes a video/audio player device 41, a lightening device 42, an air conditioner device 43 and a motor-driven curtain 44. As such a novel circumstances control device is thus formed by having the above described structure.

When the present invention is operated, the power source input port 21 is connected to an external power device to provide a DC input voltage of 5V to 24V. Each of the switch units 1 is operated with cooperation with the mode selection mechanism 3. The mode selection mechanism 3 uses the first mode unit 31, the second mode selection mechanism 32, the third mode unit 33, the fourth mode unit 34, the fifth mode unit 35, the six mode unit 36, and the seven mode unit 37 to at least set the following circumstances controls with cooperation with each of the switch units 1.

The first mode unit 31 is used to a self-test on the circumstances control device, e.g. a light presentation indicating a normal state is performed when a signal is trigger. The second mode unit 32 is used to perform a first circumstances control. The third mode unit 33 is used to perform a second circumstances control when the switch unit 1 is activated. The fourth mode unit 34 is used to alternatively perform the first and second circumstances controls. The fifth mode unit 35 is used to alternatively perform the first, second, third and fourth circumstances controls. The sixth mode unit 36 is used to perform the first circumstances control when the switch units 1 are activated. When the switches units 1 are closed, the second circumstances controls are performed, and then the third and fourth circumstances controls are performed. The seven mode units 37 are used for an extended use. The above described circumstances controls may be controlled by using the corresponding switch units 1, and the various circumstances are set according to the corresponding switch units 1 without the limitation of the above description.

Herein, it is described for the case where the user intends to use the video/audio player device 41 (may be corresponded to the third mode unit 33):

When the user desires to use the video/audio player device 41, e.g. the projector, it is expected to activate the switch unit 1 as having been set in a projector player mode, so that the selection mechanism 3 selects the third mode unit 33 to be performed. At this time, the lightening device 42 may be adjusted into having an appropriate light source. Further, the projector may be played after the motor-driven curtain may be closed, e.g. the second circumstances controls. After the projector is finished with the playing, the switch unit 1 associated with the projector play mode is closed. And the lightning device 42 and the motor-driven curtain 44 are recovered to their original states (e.g. the first circumstances control). As such, the mode selection mechanism 3 may activate the appliance device 4 by using the various modes, and further launch different circumstances controls according to the corresponding conditions and requirements. This may be undertaken without using complicated switch devices and thus a simple operation and use effectiveness may be achieved.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. A circumstances control device, comprising:
a plurality of switch units;
an input unit, connected to each of the plurality of switch units;
a mode selection mechanism, connected to the input unit; and
a plurality of appliance devices, connected to the mode selection mechanism.

2. The circumstances control device as claimed in claim 1, wherein each of the switch units is a trigger switch.

3. The circumstances control device as claimed in claim 1, wherein each of the plurality of switch units is a button switch.

4. The circumstances control device as claimed in claim 1, some of the plurality of switch units are a trigger switch while the others are a button switch, respectively.

5. The circumstances control device as claimed in claim 1, wherein the input unit is a digital port, and a power source input port is arranged between the input unit and each of the switch units.

6. The circumstances control device as claimed in claim 5, wherein each of the plurality of power source input port is supplied with a voltage of 5V to 24V.

7. The circumstances control device as claimed in claim 1, wherein the mode selection mechanism comprises a first mode unit, a second mode unit, a third mode unit, a fourth mode unit, a fifth mode unit, a sixth mode unit, and a seventh mode unit.

8. The circumstances control device as claimed in claim 1, wherein each of appliance devices comprises a video/audio player device, a lightening device, an air-conditioner device, and a power-driven curtain.
